(19) United States
(12) Patent Application Publication
(10) Pub. No.: US 2012/0195236 A1
(43) Pub. Date: Aug. 2, 2012

(54) System for Multilocation Calling Line Identification Provisioning

(75) Inventor: Erik Knight, Phoenix, AZ (US)

(73) Assignee: COMVOICE HOLDINGS LLC, Phoenix, AZ (US)

(21) Appl. No.: 13/019,433

(22) Filed: Feb. 2, 2011

(51) Int. Cl. H04L 12/16

(52) U.S. Cl. 370/259; 370/352

(57) ABSTRACT

Utilizing the system for multilocation CLID provisioning, a VoIP carrier may hold two or more sets of CLID information for a given endpoint. A first set may be a Main CLID information set, containing the multilocation CLID information of a business's central telephone number and address. A second set may be an E911 CLID information set, containing the true telephone number and physical location. A third set of CLID information may likewise be stored for other purposes. Upon a VoIP endpoint dialing an emergency number, such as 911, the system for multilocation CLID provisioning allows a VoIP carrier to exchange the Main CLID information for the E911 CLID information prior to sending the information to the E911 gateway and connecting the endpoint with the PSAP. The PSAP is then able to view the E911 CLID information, thereby having a true physical location and telephone number associated with the calling endpoint.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

The invention relates to caller identification (CID) systems, or calling line identification (CLID) systems, for Voice over Internet Protocol (VoIP) applications, particularly with respect to enhanced 911 (E911) service.

2. Description of the Related Art

E911 service has been problematic to implement in a VoIP setting, due to the difficulty in establishing the physical location of a VoIP user, or endpoint. Further problems arise when one takes into account multilocation endpoints. A multilocation endpoint occurs when an entity, such as a business, has multiple locations which should display the same CLID information to the called telephone number. This promotes the impression that all calls from the various multilocation endpoints are generated from a central location for the business.

Many of the problems arise due to the necessity to comply with governmental regulations with respect to emergency services, such as E911. Failure to report an accurate physical location with the CLID information when calling a Public Safety Answering Point (PSAP) could generate severe penalties to VoIP carriers.

Many VoIP carriers have attempted to solve this problem by specifically excluding 911 service to its endpoints. This creates a hazard, due to the endpoint's inability to contact a PSAP.

Other VoIP carriers have attempted to solve this problem by disallowing multilocation endpoints and simply utilizing an endpoint's true location in CLID information transmitted to called numbers. This creates a problem for businesses that would like to centralize their image, showing a single telephone number and address for contact purposes.

A solution is needed to address one or more of these shortcomings in the prior art.

### BRIEF SUMMARY OF THE INVENTION

The present invention provides a way to be able to fully implement multilocation endpoints within a VoIP system while still fully complying with E911 regulations.

Utilizing the system for multilocation CLID provisioning, a VoIP carrier may hold two or more sets of CLID information for a given endpoint. A first set may be a Main CLID information set, containing the multilocation CLID information of a business's central telephone number and address, for example. A second set may be an E911 CLID information set, containing the true telephone number and physical location. A third set of CLID information may likewise be stored for other purposes.

Upon a VoIP endpoint dialing an emergency number, such as 911, the VoIP carrier determines whether the endpoint is a multilocation endpoint. If the endpoint is multilocation, the VoIP carrier then retrieves the endpoint's E911 CLID information from a database prior and exchanges the E911 CLID information for the Main CLID information prior to sending the information to the E911 gateway and connecting the endpoint with the PSAP. Once the endpoint and the PSAP are connected, the PSAP is able to view the E911 CLID information, thereby having a true physical location and telephone number associated with the calling endpoint.

### BRIEF DESCRIPTION OF THE SEVERAL VIEWS OF THE DRAWING

FIG. 1 depicts a flowchart of the process of entering new endpoints, with associated Main CLID and E911 CLID information into a VoIP system database.

FIG. 2 depicts a flowchart of the process of selecting and returning CLID information.

### DETAILED DESCRIPTION OF THE INVENTION

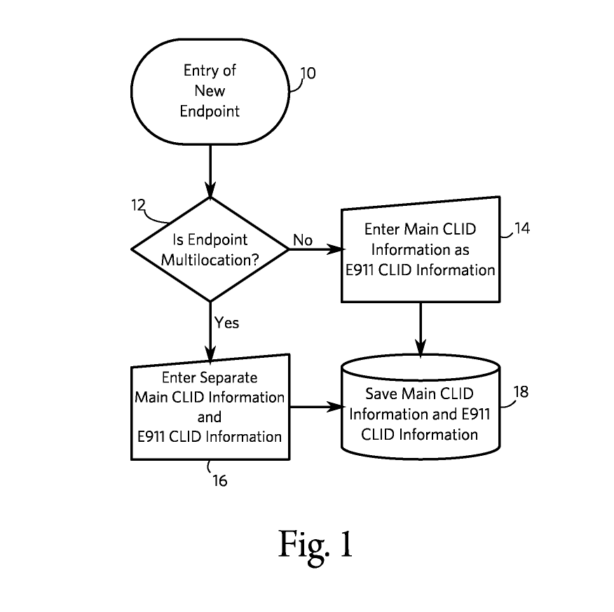

In a first embodiment of the system for multilocation CLID provisioning, a database of CLID information should first be established. Referring now to FIG. 1, a VoIP carrier first begins entry of a new VoIP user or subscriber, otherwise known as an endpoint, at step 10. At this step, the VoIP carrier should obtain any required information for a Main CLID, such as a name, telephone number, and physical address.

At step 12, the VoIP carrier then determines whether the endpoint is a multilocation endpoint. If the endpoint is a multilocation endpoint, the VoIP carrier stets a multilocation Boolean variable (“multilocation flag”) to true, otherwise the VoIP carrier sets the multilocation flag to false.

If the multilocation flag is false, the VoIP carrier enters the Main CLID information and multilocation flag value at step 14, and saves the Main CLID information and multilocation flag value to the database at step 18.

If the multilocation flag is true, the VoIP carrier then proceeds to step 16 and obtains separate E911 CLID information, including the endpoint's name, telephone number, and physical address. The Main CLID information, multilocation flag value and E911 CLID information are then saved to the database at step 18.

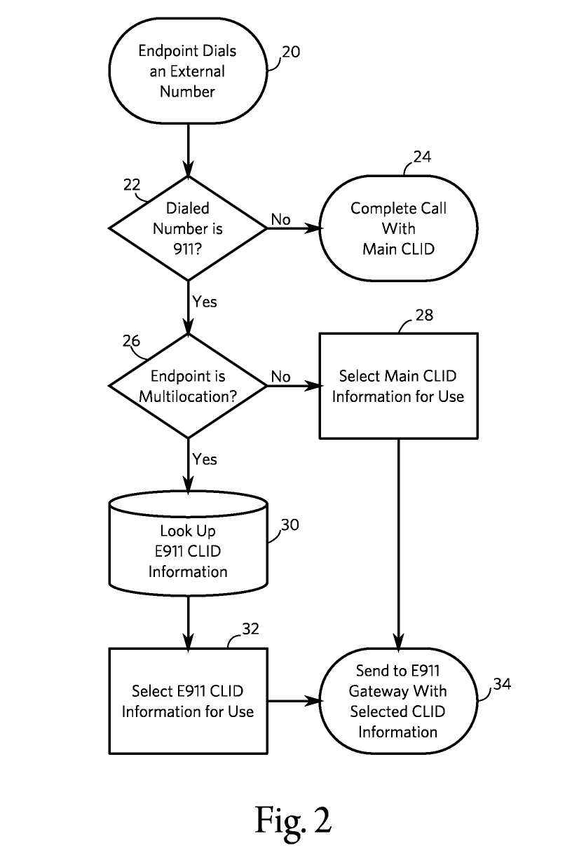

After the database is established, the system is ready for use by the endpoint. Referring now to FIG. 2, an endpoint may dial a telephone number from their VoIP telephone at step 20. The VoIP carrier then checks the telephone number dialed at step 22. If the dialed number is not an emergency number, such as 911, the call is completed utilizing the Main CLID at step 24. This allows the endpoint to be able to utilize a main calling center's CLID information for regular telephone calls.

If the VoIP carrier determines the dialed number is an emergency number at step 22, the VoIP carrier then checks the value of the multilocation flag in the database at step 26. If the multilocation flag for the endpoint is set to false, no changes are necessary and the VoIP carrier may transmit the Main CLID for use at step 28. The VoIP carrier then connects the endpoint to the E911 gateway using the Main CLID at step 34.

If the multilocation flag for the endpoint is set to true, the VoIP carrier then instead retrieves the E911 CLID information from the database at step 30. The VoIP carrier then selects the E911 CLID information for use at step 30, prior to connecting the endpoint to the E911 gateway at step 34.

After the call is connected to the E911 gateway, the call is routed to the appropriate public safety access point (PSAP) for the endpoint's location. Upon receiving the call, the PSAP is able to view the E911 CLID information, and access the endpoint's physical location, rather than the Main CLID information that is utilized for non-emergency telephone calls.

In an alternate embodiment, the VoIP carrier eliminates the need for the multilocation flag by maintaining two databases of CLID information. A first Main CLID database is utilized for non-emergency telephone calls placed by endpoints. A second E911 CLID database is utilized for emergency telephone calls. In cases where an endpoint is not a multilocation endpoint, the information for the endpoint in each of the Main CLID database and the E911 CLID database is identical. In cases where an endpoint is a multilocation endpoint, the information for the endpoint in the Main CLID database will match the information desired to be distributed with non-emergency numbers and the information in the E911 CLID database is the information including the endpoint's true name, telephone number, and physical location.

When an endpoint dials a telephone number, the VoIP carrier checks the telephone number dialed. If the telephone number is a non-emergency number, the VoIP carrier retrieves the information stored in the Main CLID database. The VoIP carrier then sends the Main CLID information when connecting the call. If the telephone number dialed is an emergency number, the VoIP carrier retrieves the information stored in the E911 CLID database. The VoIP carrier then sends the E911 CLID information when connecting the call to the E911 gateway.

After the call is connected to the E911 gateway, the call is routed to the appropriate public safety access point (PSAP) for the endpoint's location. Upon receiving the call, the PSAP is able to view the E911 CLID information, and access the endpoint's physical location, rather than the Main CLID information that is utilized for non-emergency telephone calls.

I claim:

1. A method for multilocation calling line identification (CLID) provisioning, the method comprising the steps of:
(A) providing a CLID information database;
(B) determining if a calling endpoint is multilocation;
(C) saving two or more CLID information sets to the CLID information database;
(D) dialing a destination telephone number from the calling endpoint;
(E) selecting a chosen CLID information set based on one or more established criteria;
(F) retrieving the chosen CLID information set from the CLID information database; and
(G) connecting the calling endpoint to the destination telephone number, providing the chosen CLID information set as CLID information.

2. The method of claim 1, wherein the one or more established criteria includes at least one of a determination of whether the destination telephone number is an emergency number and a determination of whether the calling endpoint is multilocation.

3. The method of claim 1, wherein the two or more CLID information sets comprise a caller name, a caller telephone number, and a caller address.

4. A method for multilocation CLID provisioning, the method comprising the steps of:
(A) providing a CLID information database;
(B) determining if a calling endpoint is multilocation;
(C) saving two or more CLID information sets to the CLID information database, the two or more CLID information sets comprising
(i) a caller name,
(ii) a caller telephone number, and
(iii) a caller address;
(D) dialing a destination telephone number from the calling endpoint;
(E) selecting a chosen CLID information set based on one or more established criteria, the one or more established criteria comprising at least one of
(i) a determination of whether the destination telephone number is an emergency number, and
(ii) a determination of whether the calling endpoint is multilocation;
(F) retrieving the chosen CLID information set from the CLID information database; and
(G) connecting the calling endpoint to the destination telephone number, providing the chosen CLID information set as CLID information.
